(19) United States
(12) Patent Application Publication
(10) Pub. No.: US 2026/0232023 A1
(43) Pub. Date: Aug. 13, 2026

(54) AEROSOL PROVISION SYSTEM, HEATER ASSEMBLY AND METHOD

(71) Applicant: Nicoventures Trading Limited, London (GB)

(72) Inventor: Howard ROTHWELL, London (GB)

(21) Appl. No.: 19/150,743

(22) PCT Filed: Jan. 25, 2024
(86) PCT No.: PCT/GB2024/050202

§ 371 Date: Jul. 24, 2025

(30) Foreign Application Priority Data
Jan. 27, 2023 (GB) 2301168.7

(51) Int. Cl. A24F 40/465; A24F 40/10; A24F 40/46; A24F 40/485; A24F 40/70; H05B 3/02

(52) U.S. Cl. CPC A24F 40/465; A24F 40/10; A24F 40/46; A24F 40/485; A24F 40/70; H05B 3/02

(57) ABSTRACT

An aerosol provision system including an aerosol-generating material storage portion for storing aerosol-generating material, a heater assembly, where the heater assembly includes a substrate; a heater layer configured to generate heat when supplied with energy, the heater layer provided on a first surface of the substrate; and one or more capillary tubes extending from another surface of the substrate through the heater layer provided at the first surface of the substrate; and a heat-sink layer. The heater assembly is arranged such that at least the another surface is in fluid communication with the aerosol-generating material storage portion. The heat-sink layer extends across at least a part of the another surface of the substrate and is configured to allow aerosol-generating material to pass through the heat-sink layer to the one or more capillary tubes of the heater assembly.

### CROSS-REFERENCE TO RELATED APPLICATIONS

This present application is a National Phase entry of PCT Application No. PCT/GB2024/050202, filed Jan. 25, 2024, which claims priority from Great Britain Application No. 2301168.7, filed Jan. 27, 2023, each of which are fully incorporated herein by reference in their entireties.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporisation. An aerosol source for an aerosol provision system may thus comprise a heater having a heating element arranged to receive source liquid from the reservoir, for example through wicking/capillary action. While a user inhales on the device, electrical power is supplied to the heating element to vaporise source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such electronic aerosol provision systems are provided with heater assemblies suitable for heating the source liquid to form an aerosol. An example of such a heater assembly is a wick and coil heater assembly, which is formed of a coil of wire (typically nichrome NiCr 8020) wrapped or coiled around a wick (which typically comprises a bundle of collected fibres, such as cotton fibres, extending along the longitudinal axis of the coil of wire). Ends of the wick extend either side of the coil of wire and are inserted into the reservoir of source liquid. However, such heater assemblies are not necessarily suited for all applications or all configurations of electronic aerosol provision systems.

So-called microfluidic heater assemblies have been proposed to try to address some of the issues of the abovementioned heater assemblies. However, some microfluidic heater assemblies may not provide desired heating characteristics for certain applications.

Various approaches are described which seek to help address some of these issues.

### SUMMARY

According to a first aspect of certain embodiments there is provided an aerosol provision system, the aerosol provision system including an aerosol-generating material storage portion for storing aerosol-generating material, a heater assembly, where the heater assembly includes a substrate; a heater layer configured to generate heat when supplied with energy, the heater layer provided on a first surface of the substrate; and one or more capillary tubes extending from another surface of the substrate through the heater layer provided at the first surface of the substrate; and a heat-sink layer. The heater assembly is arranged such that at least the another surface is in fluid communication with the aerosol-generating material storage portion. The heat-sink layer extends across at least a part of the another surface of the substrate and is configured to allow aerosol-generating material to pass through the heat-sink layer to the one or more capillary tubes of the heater assembly. The heat-sink layer is configured to absorb heat energy generated by the heater layer and transmitted through the substrate and distribute the absorbed heat energy through the heat-sink layer.

According to a second aspect of certain embodiments there is provided a heater assembly for an aerosol provision system, the heater assembly including a substrate; a heater layer configured to generate heat when supplied with energy, the heater layer provided on a first surface of the substrate; one or more capillary tubes extending from another surface of the substrate through the heater layer provided at the first surface of the substrate; and a heat-sink layer. The heater assembly is arranged such that at least the another surface is able to be placed in fluid communication with an aerosol-generating material storage portion. The heat-sink layer extends across at least a part of the another surface of the substrate and is configured to allow aerosol-generating material to pass through the heat-sink layer to the one or more capillary tubes of the heater assembly. The heat-sink layer is configured to absorb heat energy generated by the heater layer and transmitted through the substrate and distribute the absorbed heat energy through the heat-sink layer.

According to a third aspect of certain embodiments there is provided a method for manufacturing a heater assembly and heat-sink layer for an aerosol provision system or an aerosol provision system comprising a heater assembly and a heat-sink layer, the method including: providing a substrate; providing a heater layer on a first surface of the substrate, the heater layer configured to generate heat when supplied with energy; providing one or more capillary tubes extending from another surface of the substrate through the heater layer provided at the first surface of the substrate; and providing a heat-sink layer. The heater assembly is arranged such that at least the another surface is in fluid communication with an aerosol-generating material storage portion or is able to be placed in fluid communication with an aerosol-generating material storage portion. The heat-sink layer extends across at least a part of the another surface of the substrate and is configured to allow aerosol-generating material to pass through the heat-sink layer to the one or more capillary tubes of the heater assembly. The heat-sink layer is configured to absorb heat energy generated by the heater layer and transmitted through the substrate and distribute the absorbed heat energy through the heat-sink layer.

According to a fourth aspect of certain embodiments there is provided aerosol provision means, the aerosol provision means including aerosol-generating material storage means for storing aerosol-generating material; heater means, the heater means including a substrate; a heater layer means configured to generate heat when supplied with energy, the heater layer means provided on a first surface of the substrate; and capillary means extending from another surface of the substrate through the heater layer provided at the first surface of the substrate; and heat-sink means. The heater means is arranged such that at least the another surface is in fluid communication with the aerosol-generating material storage means. The heat-sink means extends across at least a part of the another surface of the substrate and is configured to allow aerosol-generating material to pass through the heat-sink means to the one or more capillary means of the heater means. The heat-sink means is configured to absorb heat energy generated by the heater layer means and transmitted through the substrate and distribute the absorbed heat energy through the heat-sink layer.

According to a fifth aspect of certain embodiments there is provided heater means for an aerosol provision system, the heater means including a substrate; a heater layer means configured to generate heat when supplied with energy, the heater layer means provided on a first surface of the substrate; capillary means extending from another surface of the substrate through the heater layer provided at the first surface of the substrate; and heat-sink means. The heater means is arranged such that at least the another surface is able to be placed in fluid communication with an aerosol-generating material storage means. The heat-sink means extends across at least a part of the another surface of the substrate and is configured to allow aerosol-generating material to pass through the heat-sink means to the one or more capillary means of the heater means. The heat-sink means is configured to absorb heat energy generated by the heater layer means and transmitted through the substrate and distribute the absorbed heat energy through the heat-sink means.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is a schematically shows an exploded view of a cartomiser suitable for use in the aerosol provision system of FIG. 1, whereby the cartomiser is provided with a heat-sink layer;

FIG. 3 is a cross-sectional view of a cartomiser suitable for use in the aerosol provision system of FIG. 1, whereby the cartomiser is provided with a heat-sink layer;

FIG. 4 schematically shows a heater assembly according in accordance with aspects of the present disclosure, where the heater assembly is shown in perspective view and comprises one or more capillary tubes extending through the heater assembly;

FIG. 5 schematically shows a heat-sink layer in perspective view according to a first implementation of the present disclosure;

FIG. 6 schematically shows a heat-sink layer in perspective view according to a second implementation of the present disclosure; and

FIG. 7 is a method in accordance with aspects of the present disclosure for forming a heater assembly and heat-sink layer for an aerosol provision system or an aerosol provision system comprising a heater assembly and a heat-sink layer.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapour) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavours, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or is derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In accordance with the present disclosure, a heater assembly, that comprises an electrically resistive layer capable of generating heat when a current is applied thereto, a substrate on a surface of which is disposed the electrically resistive layer, and one or more capillary tubes extending through the heater assembly to the electrically resistive layer, is provided in conjunction with a heat-sink layer. The heat-sink layer is provided at a position between the heater assembly (in particular a surface of the heater assembly that contacts an aerosol-generating material storage portion comprising aerosol-generating material). The heat-sink layer is configured to absorb heat energy generated by the electrically resistive layer and transmitted through the substrate and distribute the absorbed heat energy through the heat-sink layer. Subsequently, localised heating of the heat-sink layer can be avoided, which may otherwise cause damage to the heat-sink layer, and subsequently the heat-sink layer can be uniformly heated. Additionally, by virtue of the heat-sink layer being uniformly heated, the heat-sink is able to uniformly dissipate heat energy to any aerosol-generating material that is located in the aerosol-generating material storage portion and in the vicinity of the heater assembly. Thus, localised regions of liquid aerosol-generating material having different properties caused by heating (e.g., viscosity) can be avoided, and the characteristics of the liquid aerosol-generating material are therefore more uniform across the heater assembly, and subsequently the performance characteristics of the heater assembly may be more uniform. Therefore, the performance characteristics of the heater assembly may be influenced by the presence of the heat-sink layer, and in particular, may be uniform or substantially uniform across spatial positions of the heater assembly in the presence of the heat-sink layer.

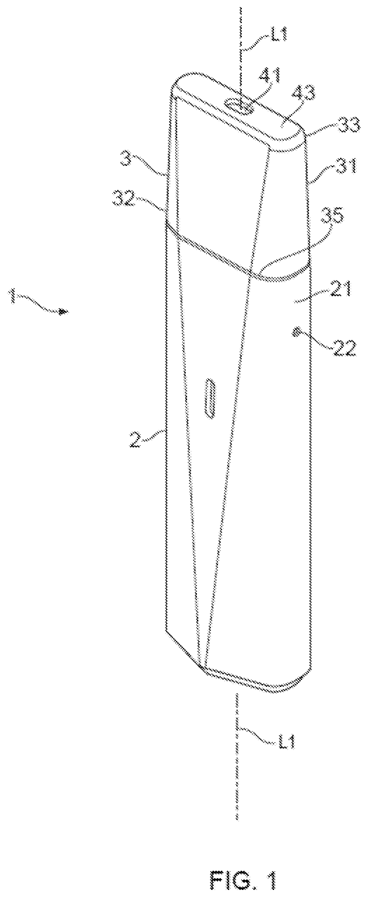

FIG. 1 schematically shows an aerosol provision system 1 in accordance with aspects of the present disclosure. The aerosol provision system 1 comprises an aerosol provision device 2 and a consumable 3, herein shown and referred to as a cartomiser 3. The aerosol provision device 2 and the cartomiser 3 together form the aerosol provision system 1.

The cartomiser 3 is configured to engage and disengage with the aerosol provision device 2. That is, the cartomiser 3 is releasably connected/connectable to the aerosol provision device 2. More specifically, the cartomiser 3 is configured to engage/disengage with the aerosol provision device 2 along the longitudinal axis L1. The cartomiser 3 and aerosol provision device 2 are provided with suitable interfaces to allow the cartomiser 3 and aerosol provision device 2 to engage/disengage from one another, e.g., a push fit interface, a screwthread interface, etc.

The cartomiser 3 comprises a reservoir which stores an aerosol-generating material. Accordingly, the reservoir may also be referred to as an aerosol-generating material storage portion. In the following, the aerosol-generating material is a liquid aerosol-generating material. The liquid aerosol-generating material (herein sometimes referred to simply as liquid, source liquid or e-liquid) may be a conventional e-liquid which may or may not contain nicotine. However, it should be appreciated that other liquids and/or aerosol-generating materials may be used in accordance with the principles of the present disclosure. The cartomiser 3 is able to be removed from the aerosol provision device 2 when, for example, the cartomiser 3 requires refilling with liquid or replacement with another (full) cartomiser 3.

The aerosol provision device 2 comprises a power source (such as a rechargeable battery) and control electronics. As will be described below, the cartomiser 3 comprises an electrically powered heater assembly. When the cartomiser 3 is coupled to the aerosol provision device 2, the control electronics of the aerosol provision device 2 are configured to supply electrical power to the heater assembly of the cartomiser 3 to cause the heater assembly to generate an aerosol from the liquid aerosol-generating material supplied thereto. The control electronics may be provided with various components to facilitate/control the supply of power to the cartomiser 3. For example, the control electronics may be provided with an airflow sensor (not shown) configured to detect when a user of the aerosol provision system 1 inhales on the aerosol provision system and to supply power in response to such a detection and/or a push button (not shown) which is pressed by the user and to supply power in response to such a detection. Additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

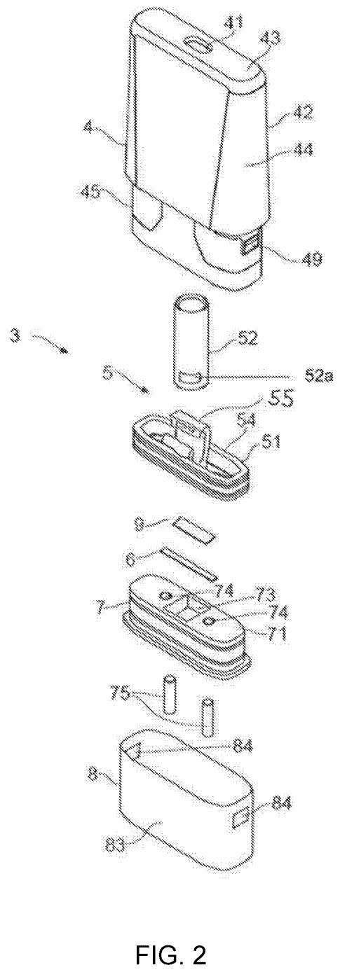

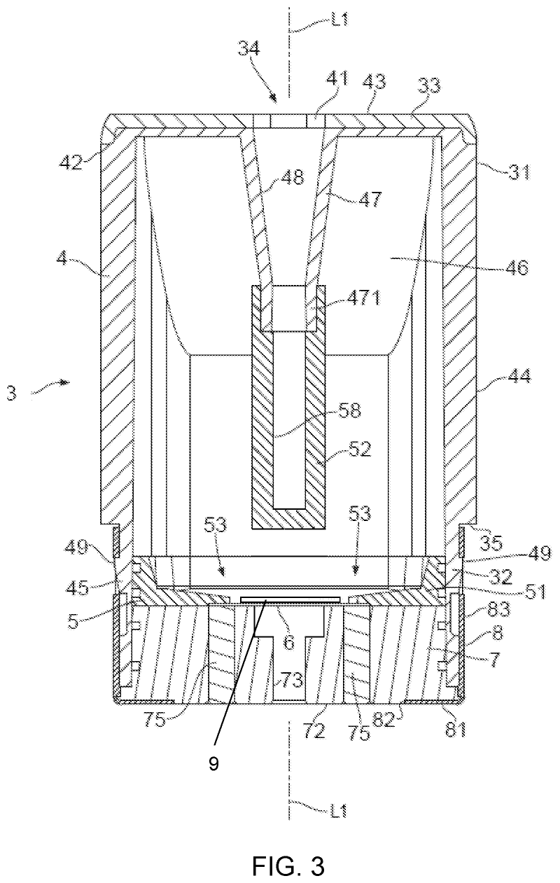

FIGS. 2 and 3 show an example cartomiser 3 suitable for use in the aerosol provision system of FIG. 1. FIG. 2 schematically shows the cartomiser 3 in a perspective and exploded view (exploded along the longitudinal axis L1), while FIG. 3 shows a cross-sectional view of the cartomiser 3. From the views of FIGS. 2 and 3, it may be seen that the cartomiser 3 is assembled from a stack of components: an outer housing 4, an upper clamping unit 5, a heater assembly 6, a heat-sink layer 9, a lower support unit 7 and an end cap 8.

The cartomiser 3 has a top end 31 and a bottom end 32 which are spaced apart along the longitudinal axis L1, which is the longitudinal axis of the cartomiser 3 as well as being the longitudinal axis of the aerosol provision system 1. The top end 31 of the cartomiser 3 defines a mouthpiece 33 of the aerosol provision system 1 (around which a user may place their mouth and inhale). The mouthpiece 33 includes a mouthpiece orifice 41 which is provided at the top end 42 of outer housing 4 in the centre of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomiser 3, the bottom end 45 of the outer housing is open, but upon assembly the bottom end 45 is closed by a plug formed by the upper clamping unit 5 and the lower support unit 7 which are stacked together with the heater assembly 6 and heat-sink layer 9 positioned therebetween.

The upper clamping unit 5 is an intermediate component of the stack of components. The upper clamping unit 5 includes a foot 51 in the form of a block. The foot 51 includes a well 53 which descends from a flat top surface to a flat bottom surface of the foot 51. At the bottom surface, the well 53 is open. As will be described in more detail below, the heater assembly 6 extends across the opening of the well 53/foot 51, effectively sealing the opening of the well 53/foot 51. In some implementations, the heat-sink layer 9 is arranged between the foot 51 of the upper clamping unit 5 and the heater assembly 6, for example, clamped between the upper clamping unit 5 and the heater assembly 6, but as can be seen in particular from FIG. 3, the heat-sink layer 9 is positioned so as to extend across a part of the heater assembly 6 (where the heat-sink layer 9 may be adhered or otherwise bonded to the heater assembly 6, or integrally formed as part of the heater assembly 6). The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The lower support unit 7 is in the form of a block having a broadly flat top surface 71 and a flat bottom surface 72. A central air passage 73 extends upwardly from the bottom surface 72 towards the top surface 71. When the heater assembly 6 is positioned between the upper clamping unit 5 and the lower support unit 7, the central air passage 73 is provided in fluid communication with the heater assembly 6. On each side of the air passage 73, the block of the lower support unit 7 includes a through hole 74. In the example cartomiser 3 of FIGS. 2 and 3, a co-moulded contact pad 75 in the form of a pin is inserted into the through holes 74. More specifically, each contact pad 75 is a press fit in its respective through hole. Each contact pad 75 provides an electrical connection path from the bottom surface 72 to a respective end portion of the heater assembly 6 when the heater assembly 6 is positioned between the top surface 71 of the lower support unit 7 and the bottom surface of the upper clamping unit 5.

At least one of the upper clamping unit 5 and lower support unit 7 includes a recessed portion (not shown) which is broadly sized and shaped in accordance with the size and shape of heater assembly 6 and/or heat-sink layer 9 (that is, for example, having a similar length, width and overall depth). Accordingly, the recessed portion helps to locate and hold the heater assembly 6 and/or heat-sink layer 9 when the upper clamping unit 5 and lower support unit 7 are engaged with one another.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir 46.

As shown in FIGS. 2 and 3, the cartomiser 3 includes an end cap 8 at its bottom end. The end cap 8 is made of metal and serves to assist with retaining the cartomiser 3 in the aerosol provision device 2 when the cartomiser 3 is plugged in to the top end of the aerosol provision device 2, because, in this example, the aerosol provision device 2 is provided with magnets which are attracted to the metal of the end cap 8. The end cap 8 has a bottom wall 81 with a central opening (see FIG. 3). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 and heat-sink layer 9 which is located between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomiser 3 could be provided with indentations which engage with projections at the top end 21 of the main housing 2, so that a releasable connection is provided between the cartomiser and the main housing.

In any case, the cartomiser 3 is provided what may more generally be referred to as a device interface which is a part of the cartomiser 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomiser 3 may encompass any part or parts of the cartomiser 3 that contact, abut, engage or otherwise couple to the main housing 2.

When the components of the cartomiser 3 have been assembled together, an overall air passage exists from the bottom end 32 to the top end 31 of the cartomiser 3. The overall air passage is formed initially by the air passage 73, which opens towards the surface of the heater assembly 6 (see FIGS. 2 and 3). The upper clamping unit 5 includes side channels 55 formed as part of the upper clamping unit and extending from openings in the foot 51 that broadly align with the air passage 73 upwards from the foot 51 and curve inwards at the upper parts of the side channels 55 (as best seen in FIG. 2). Correspondingly, air is permitted to flow from the air passage 73 along the side channels 55. It should be appreciated that the side channels 55 are surrounded by the reservoir 46/well 53 and as such form an air channel that is not directly fluidly connected to the reservoir 46/well 53. Additionally, an air tube 52 is provided which defines an air passage 58. The air tube 52 is arranged centrally in the cartomiser 3 (i.e., coaxial with the longitudinal axis L1) and is arranged to couple between the side channels 55 and an air tube 47 which extends downwards from the mouthpiece orifice 41 in the top face 43 of the outer housing 4 (see FIG. 3). The air tube 52 includes one or more side openings 52a which are arranged to fluidly couple to the side channels 55. Therefore, air that exits from the side channels 55 is able to be passed to the air tube 52 and along the air passage 58, before exiting the air passage 58 to an air passage 48 provided in the air tube 47. Hence, it can be seen that an overall air passage extends from the air passage 73 which encompasses a region adjacent the heater assembly 6, to the side channels 55, air passage 58, air passage 48 and then to the mouthpiece orifice 41 when it subsequently is delivered to a user.

It should be appreciated that the various components forming the overall air passage are joined, fixed or abutted in such a way as to substantially prevent liquid aerosol-generating material passing into the air passage. Therefore, the joins between components may be adhered, sealed or fixed in any suitable way (for example, through ultrasonic welding). Additionally, it should be appreciated that some of the abovementioned components may be integrally formed. For example, the air tube 52 may be integrally formed with the air tube 47. Alternatively, the air tube 52 may be integrally formed with the upper clamping unit 5.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

When the components of the cartomiser 3 have been assembled, the heater assembly 6 is arranged such that at least a surface thereof faces towards the well 53. Provided between the surface of the heater assembly 6 and the well 53 is provided the heat-sink layer 9. In some implementations, the heat-sink layer 9 extends across (at least) the exposed surface of the heater assembly that would otherwise contact the well 53. In such implementations, the heat-sink layer 9 is in direct contact with the liquid aerosol-generating material stored in the reservoir 46. However, in other implementations, such as the described implementation of FIGS. 2 and 3 (see FIG. 3 in particular), the heat-sink layer 9 extends across a part of the exposed surface of the heater assembly 6, thereby resulting in at least a part of the exposed surface of the heater assembly 6 being in direct contact with the liquid aerosol-generating material in the reservoir 46. Liquid aerosol-generating material in the reservoir 46 is therefore able to pass to the surface of the heater assembly 6 through the well 53 and the heat-sink layer 9. Subsequently, in use, the heater assembly 6 vaporises the liquid aerosol-generating material and the generated vapour is capable of being entrained in the airflow along the overall air passage and delivered to the user through the mouthpiece orifice.

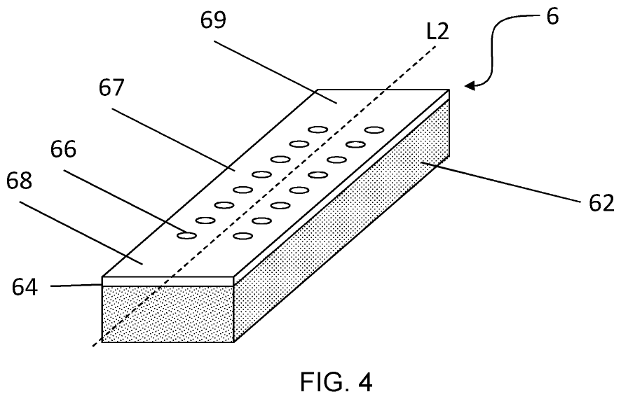

Turning now to the heater assembly 6, the heater assembly 6 is a microfluidic heater assembly. FIG. 4 illustrates the microfluidic heater assembly 6, where FIG. 4 schematically shows the heater assembly 6 in perspective view.

The microfluidic heater assembly 6 comprises a substrate 62 and an electrically resistive layer 64 disposed on a surface of the substrate 62.

The substrate 62 is formed from a non-conductive material, such as quartz (silicon dioxide); however, it should be appreciated that other suitable non-conductive materials may be used, such as ceramics, for example. In some implementations, the substrate 62 implementations may be formed from a porous material. The porous substrate 62 may be formed from naturally porous materials, such as sponges, porous stones or ceramics etc., or via materials that are engineered to be porous, such as sintered metals or other materials. These materials, either formed naturally or engineered, have pores or hollow regions which are interconnected and define passages that follow a substantially random pathway through the material. In other implementations, the substrate 62 may be considered substantially impermeable. That is, the substrate 62 may take the form of an impermeable block of material. The material of the substrate 62 is not of primary significance to the principles of the present disclosure.

The electrically resistive layer 64 is formed from any suitable electrically conductive material, for example a metal or a metal alloy such as titanium or nickel chromium. The electrically resistive layer 64 may be formed on the surface of the substrate 62 in any suitable way. For example, the electrically resistive layer 64 may be provided as a film that is adhered or otherwise bonded to the surface of the substrate 62. Alternatively, the electrically resistive layer 64 may be formed though a deposition technique, such as chemical or vapour deposition. The way in which the electrically resistive layer 64 is formed and the materials it is made therefrom is not of primary significance to the principles of the present disclosure.

The heater assembly 6 is broadly in the form of a rectangular cuboidal block, elongate in the direction of a longitudinal axis L2. The heater assembly 6 has the shape of a strip and has parallel sides. The heater assembly 6 has parallel upper and lower major surfaces and parallel side surfaces and parallel end surfaces. In the implementation of FIG. 4, the electrically resistive layer 64 forms the upper major surface. The heater assembly has a length, a width and a thickness. In the shown implementation of FIG. 4, the length of the heater assembly 6 is 10 mm and its width is 1 mm, while the thickness of the heater assembly is on the order of 0.12 mm (where the thickness of the substrate 62 is approximately 0.10 mm, and the thickness of the electrically resistive layer 64 is approximately 0.02 mm). The small size of the heater assembly 6 enables the overall size of the cartomiser 3 to be reduced and the overall mass of the components of the cartomiser 3 to be reduced. However, it should be appreciated that in other implementations, the heater assembly 6 may have different dimensions depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 4, the length of the central portion 67 (relative to the lengths of the end portions 68, 69) has been exaggerated for reasons of visual clarity. When the heater assembly 6 is in situ in the cartomiser, the central portion 67 is positioned in communication with the air passage 73. The central portion 67 extends across the top end of the air passage 73 of the lower support unit 7. The end portions 68, 69 are clamped between the upper clamping unit 5 and the lower support unit 7. Additionally, in the described implementation, it should be appreciated that the central portion 67 is broadly aligned with the well 53 of the upper clamping unit 5.

In the central portion 67 of the heater assembly 6, a plurality of capillary tubes 66 are provided. The openings of the capillary tubes 66 are shown on the electrically resistive layer 64 in FIG. 4 (and in an exaggerated way for clarity). The capillary tubes 66 extend from one side of the heater assembly 6 to the other. More specifically, the capillary tubes 66 extend from the lower major surface of the substrate 62/heater assembly 6, through the substrate 62 toward the surface of the substrate 62 on which the electrically resistive layer 64 is disposed (forming the upper major surface of the heater assembly 6), and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5 %, within 2 % or within 1 % of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 6 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes 66 that substantially follow a linear path, is laser drilling. However, any other suitable technique may be employed in order to generate the capillary tubes 66.

The capillary tubes 66 are configured so as to transport liquid from the lower major surface of the substrate 62 (i.e., the surface of the substrate 62 opposite the electrically resistive layer 64) to the electrically resistive layer 64 disposed on the opposite surface of the substrate 62. The capillary tubes 66 may be formed based in part on the liquid aerosol-generating material to be stored in the reservoir 46 of the cartomiser 3 and subsequently used with the heater assembly 6. For example, the properties of the liquid aerosol-generating material (e.g., viscosity) in the reservoir 46 of the cartomiser 3 may dictate the configuration of the capillary tubes 66 to ensure that a suitable flow of liquid is provided to the electrically resistive layer 64. Broadly speaking, in some implementations, the capillary tubes 66 may have a diameter on the order to tens of microns, e.g., between 10 μm to 100 μm. However, it should be appreciated that capillary tubes 66 in other implementations may be sized differently.

The heater assembly 6 as described above is generally provided as a relatively small component having a relatively small footprint (as compared to more traditional heater assemblies, such as a wick and coil). This is in part due to the fact the capillary tubes 66 are formed via a manufacturing process in the heater assembly 6 (i.e., the capillary tubes are engineered, e.g., through a laser drilling process), and can therefore be designed to achieve a desired delivery of liquid aerosol-generating material to the electrically resistive layer 64. By providing a smaller component, material wastage (e.g., when the cartomiser 3 is disposed of) can be reduced. Not only can the liquid be provided more efficiently to the electrically resistive layer 64, but by manufacturing the capillary tubes 66, more control is given over the supply of liquid to the electrically resistive layer 64 (that is, the more capillary tubes of a certain diameter, the more liquid per unit time (ml/s) can be delivered to the electrically resistive layer 64).

With reference back to FIGS. 2 and 3, the heater assembly 6 is shown positioned between the upper clamping unit 5 and the lower support unit 7. In particular, the heater assembly 6 is oriented such that the electrically resistive layer 64 faces towards the lower support unit 7, while the lower major surface of the substrate 62/heater assembly 6 faces towards the upper clamping unit 5. It should be understood from FIGS. 2 and 3 that the end portions 68, 69 of the heater assembly 6 overlap the through holes and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64.

The amount of heating achieved (i.e., the temperature of the electrically resistive layer 64 that is able to be reached) may depend in part on the power supplied by the aerosol provision device 2, the electrical resistance of the electrically resistive layer 64 and the heating efficiency of the heater assembly 6 (in particular, how much of the heating energy is lost to the substrate 62 and/or environment around the electrically resistive layer 64). Equally, the amount of heating required (i.e., the temperature necessary to vaporise the liquid supplied to the resistive layer 64) will be dependent in part on the properties of the liquid supplied to the electrically resistive layer 64. For a given current applied to the electrically resistive layer 64 of the heater assembly 6, the resistance of the electrically resistive layer 64 may be set based on the particular implementation, whereby the resistance of the electrically resistive layer 64 may be dependent on the material of the electrically resistive layer 64 and the physical dimensions of the electrically resistive layer 64 (e.g., thickness).

During use of the heater assembly 6, electrical current is applied to the electrically resistive layer 64 (e.g., from a power source coupled to pads 75). The electrical current causes the electrically resistive layer 64 to generate heat. As described above, this heat is used to vaporise (aerosolise) liquid aerosol-generating material that is delivered to the electrically resistive layer 64 via the capillary tubes 66. During use, the temperature of the electrically resistive layer 64 may reach up to 150° C. or greater temperatures. Conventional e-liquid tends to vaporise around temperatures of around 180° C., for example. As noted above, the microfluidic heater assembly 6 of the present disclosure is formed to have a relatively small footprint and is relatively thin. Accordingly, in some implementations, the heat generated by the electrically resistively layer 64 (which should be sufficient to aerosolise the given liquid aerosol-generating material provided as described above) is able to propagate/conduct through the substrate 62 and subsequently cause the lower major surface of the substrate 62/heater assembly 6 to be warmed. The degree to which the lower major surface is warmed may depend on a number of factors, including the operational temperature of the electrically resistive layer 64 (i.e., the temperature the electrically resistive layer 64 reaches during operation when a current is applied thereto) and the thermal properties of the substrate (e.g., the heat capacity or specific heat capacity of the substrate 62 and/or the liquid aerosol-generating material).

In addition, in some implementations, the temperatures generated across the electrically resistive layer 64 are not uniform. That is to say, different regions of the electrically resistive layer 64 may reach higher operational temperatures than other regions of the electrically resistive layer 64. These regions of the electrically resistive layer 64 where the temperature is relatively higher may be referred to as “hot-spots” of the electrically resistive layer 64. These “hot-spots” may be the result of one or more features of the heater assembly 6 and/or the cartomiser 3. For example, “hot-spots” may occur due to the application of an electric current to the electrically resistive layer 64, whereby variations in the flow of current across the electrically resistive layer 64 and/or variations in the resistance of the electrically resistive layer 64 may cause certain regions of the electrically resistive layer 64 to reach greater temperatures than others. Additionally, or alternatively, “hot-spots” may occur due to a cooling effect applied to the heater assembly 6 only being applied in certain regions or only having an effect in certain regions. Such cooling effects may be due to the direction and/or extent of coverage of an air flow towards or in the vicinity of the heater assembly 6 (e.g., along air passage 73), whereby air flow that impinges or otherwise passes by regions of the heater assembly may help cool those regions. Subsequently, the absence or reduced effectiveness of such cooling mechanism in a particular heater assembly 6 or configuration of cartomiser 3 can lead to the formation of “hot-spots”. As the heat generated at these hot-spots travels through the substrate 62 towards the lower major surface, similar “hot-spots” may be observed at the lower major surface of the substrate 62/heater assembly 6.

In some implementations, a wicking element is provided between the lower major surface of the substrate 62 and the reservoir 46/well 53. The wicking element may be provided as a layer of wicking material covering all or the majority of the second major surface of the substrate 62. The wicking element may help with the distribution of liquid aerosol-generating material across the lower major surface of the substrate 62 so as to help provide suitable supply of liquid aerosol-generating material to the capillary tubes 66. The wicking element may also provide some regulation of the supply of liquid aerosol-generating material to the capillary tubes 66, for example by acting as permeable barrier through which the liquid aerosol-generating must pass before it can pass to the capillary tubes 66. In other words, the wicking element may help regulate the flow rate of liquid aerosol-generating material to the heater assembly 6. In addition, the wicking element may also retain liquid aerosol-generating material when the wicking element is brought out of contact with the liquid aerosol-generating material in the reservoir 46. For example, if the cartomiser 3 is inverted, liquid aerosol generating material subsequently flows to the top of the cartomiser 3 and out of contact with the heater assembly 6/wicking material. However, because the wicking material retains some liquid aerosol-generating material, this retained liquid aerosol-generating material can be supplied to the heater assembly 6 even when the cartomiser 3 is inverted, thereby allowing the aerosol provision system to continue to be used for a period of time even when inverted.

Traditional wicking elements are typically formed from natural fibrous materials, e.g., such as cotton, which have been used in conventional e-cigarette design. While such materials may offer the benefits described above, such natural fibrous materials are prone to burning or charring when exposed to certain temperatures. While natural fibrous materials have been considered suitable for some conventional e-cigarette designs, in view of the transfer of heat from the electrically resistive layer 64 to the second major surface of the substrate 62 as described above (including the generation of hot-spots), it has been found that such wicking elements formed of natural fibrous material are les suited for use with the heater assembly 6 described above. For example, in some instances, it has been found that the transferred heat can cause charring or burning of a cotton wicking element placed at the second major surface of the substrate 62.

As shown in FIGS. 2 and 3, and in accordance with the present disclosure, the cartomiser 3 is provided with a heat-sink layer 9 located between the lower major surface of the substrate 62/heater assembly 6 and the reservoir 46/well 53. The heat-sink layer 9 is provided in place of the aforementioned natural fibrous wicking material.

The heat-sink layer 9 is provided to act as a heat sink to receive and/or distribute heat energy generated by the electrically resistive layer 64 and transmitted through the substrate 62 throughout the heat-sink layer 9. In this way, any heat energy that is provided in a localised area of the substrate 62 (i.e., a hot-spot), is capable of being absorbed and distributed throughout the heat-sink layer 9. Therefore, any hot-spots generated at the second major surface are less likely to cause localised heating of the heat-sink layer 9 at a relatively higher temperature, and therefore cause any damage or reduction in performance, but instead cause a more uniform heating of the heat-sink layer 9 at a relatively lower temperature. This may subsequently reduce the chances of damage (e.g., charring or burning) in localised areas of the heat-sink layer 9.

In addition, the heat-sink layer 9 is configured to allow any absorbed heat to pass to the aerosol-generating material located in the reservoir 46 (or more particularly, to the aerosol-generating material of the reservoir 46 that is located in the vicinity of the heater assembly 6). In this way, the heat-sink layer 9 is able to dissipate any absorbed heat into the relatively large bulk of liquid aerosol-generating material of the reservoir 46, thereby acting to cool the heat-sink layer 9. Accordingly, the provision of the heat-sink layer 9 may also help regulate the temperature of the substrate 62 (and in particular the second major surface of the substrate 62).

Additionally, by arranging the heat-sink layer 9 such that it is capable of dissipating heat into the liquid aerosol-generating material of the reservoir 46, in a uniform manner, means that the liquid aerosol-generating material may also be warmed to a degree. This may have the effect of changing the physical properties of the liquid aerosol-generating material, e.g., the viscosity. For instance, a heated liquid may become less viscous (and subsequently flow more easily), and therefore may pass through the capillary tubes 66 more readily as compared to if the liquid aerosol-generating material was not warmed. This may subsequently affect the performance of the heater assembly 6 in respect of the aerosol generated (for example, in respect of the rate of generation or mass/amount of aerosol generated). However, it should be appreciated that warming the liquid aerosol-generating material to too greater an extent may cause some performance issues in terms of liquid being supplied too rapidly to the electrically resistive layer 64 (by virtue of the viscosity being reduced) thereby causing flooding of the electrically resistive layer 64 which may subsequently impact aerosol generation.

As noted above, the heat-sink layer 9 may be provided extending across the whole of the (otherwise) exposed part of the lower major surface of the heater assembly 6 or, as in the described implementation of FIGS. 2 and 3, the heat-sink layer 9 may be provided extended across only a part of the (otherwise) exposed part of the lower major surface of the heater assembly 6. For example, the heat-sink layer 9 may only extend across the parts of the lower major surface that exhibit high or higher temperatures in use (that is, the so-called “hot-spots”).

The heat-sink layer 9 absorbs and/or distributes heat energy that emanates from the lower major surface of the substrate 62/heater assembly 6. Accordingly, the heat-sink layer 9 is made of a material which is capable of absorbing the generated heat and/or distribute the generated heat throughout the heat-sink layer 9. heat-sink layer

The configuration of the heat-sink layer 9 may depend on the exact implementation at hand; e.g., the temperature the lower major surface reaches during operation and/or the way in which heat affects the properties of the liquid aerosol-generating material.

An aspect that is relevant in the design of the heat-sink layer 9 is the thermal conductivity of the heat-sink layer 9. The thermal conductivity is a measure of a material's ability to conduct heat (i.e., transfer heat energy from one surface to another). A material that has a relatively low thermal conductivity may be considered to be a better heat insulator compared to a material that has a relatively high thermal conductivity. As described above, the heat-sink layer 9 is intended to absorb and/or distribute heat emanating from the substrate 62 throughout the heat-sink layer 9 thereby providing more uniform temperatures across surface of the substrate 62/heat-sink layer 9. Accordingly, in some implementations, the heat-sink layer 9 is formed from a material that has a relatively high thermal conductivity. Hence, in implementations where only certain regions of the lower major surface of the substrate 62/heater assembly 6 reach a high temperature, a heat-sink layer 9 having a relatively higher thermal conductivity 9 may be used to disperse the heat energy across the heat-sink layer 9, therefore distributing the thermal energy throughout the heat-sink layer 9. This has the effect of reducing any localised “hot-spots” and providing a more even distribution of the heat energy across the heat-sink layer 9.

A further aspect that may be relevant in the design of the heat-sink layer 9 is the heat capacity of the heat-sink layer 9. The heat capacity is defined as the amount of heat (thermal energy) that when supplied to an object (such as the heat-sink layer 9) produces a unit change in the temperature of the object (e.g., a change of 1° C.). The heat capacity is a property of an object that is dependent on the specific heat capacity (an intrinsic property of the material(s) forming the object) and the mass of the object, where the mass of an object is defined by the density of the material of the object (another intrinsic property of the material(s) forming the object) and the volume of the object. A heat-sink layer 9 having a higher heat capacity means that the heat-sink layer 9 can absorb relatively more energy before its temperature is raised by 1° C. In other words, the temperature of the heat-sink layer 9 for a given amount of energy supplied thereto is relatively lower for materials with a higher heat capacity. This may be advantageous in the present implementations because the liquid aerosol-generating material closest to the heat-sink layer 9 may be warmed by a relatively smaller amount when the temperature of the heat-sink layer 9 is lower. Although a heat-sink layer 9 formed from a high heat capacity material may retain heat for longer, owing to the ability of the liquid aerosol-generating material to transfer heat and/or to freely move within the reservoir, the bulk liquid aerosol-generating material may still only be warmed slightly, particularly in the regions closest to the heat-sink layer 9 and the heater assembly 6. Therefore, in some implementations, it may be advantageous to provide the heat-sink layer 9 with a high heat capacity. In this regard, the heat-sink layer 9 may be constructed either from a material having a high specific-heat capacity and/or having a large mass (which can be varied for a given material by adjusting the dimensions, e.g., such as the thickness of the heat-sink layer 9).

In addition, the heat-sink layer 9 is formed form a material which is capable of withstanding the relevant temperatures generated by the electrically resistive layer 64 and subsequently transmitted through the substrate 62. A material may be considered suitable for such a purpose if the thermal degradation temperature (i.e., the temperature at which the material begins to breakdown) is above the operational temperature of the electrically resistive layer 64, and in some instances, well above the operational temperature so as to compensate for any temperature fluctuations during operation (e.g., as a result of overheating of the electrically resistive layer). In some implementations, the heat-sink layer 9 may experience temperatures of 180° C. or higher, or even of 240° C. or higher. Natural fibrous materials, e.g., such as cotton, which have been used in conventional e-cigarette design, tend to have thermal degradation temperatures that are comparable to these temperatures (e.g., cotton has a degradation temperature of around 210° C.). Therefore, in some implementations, the thermal degradation temperature of the material used to form the heat-sink layer 9 is equal to or greater than 180° C. In other implementations, the thermal degradation temperature of the material used to form the heat-sink layer 9 is equal to or greater than 240° C. For example, metal materials tend to have relatively high thermal decomposition temperatures. For instance, stainless steel has a thermal degradation temperature of in excess of 900° C.

Furthermore, in some implementations, the heat-sink layer 9 is formed of a material which has a high degree of mechanical stability. Naturally fibrous materials, such as cotton, may exhibit mechanical instability, where for example the cotton may start to fray or fibres (wisps) of the cotton material may separate from the bulk material. This may be due to mechanical vibrations or exposure to normal operating temperatures or excessive operating temperatures. In the context of the heater assembly 6, which comprises capillary tubes 66, there may be the possibility of any frayed or wisps of the cotton material getting lodge in one or more capillary tubes 66 thereby potentially obstructing or blocking the capillary tubes 66. Hence, a heat-sink layer 9 formed either from a material that exhibits good mechanical stability and/or formed in such a way as to exhibit good mechanical stability may be advantageous.

Accordingly, the heat-sink layer 9 may be formed of any suitable material that is capable of acting as described above. In some implementations, the material forming the heat-sink layer 9 has a thermal conductivity of 10 W/mK or greater. In some implementations, the material forming the heat-sink layer 9 has a thermal conductivity of 15 W/mK or greater. In some implementations, the material forming the heat-sink layer 9 has a specific heat capacity of 400 J/kgK or greater. In some implementations, the material forming the heat-sink layer 9 has a specific heat capacity of 500 J/kgK or greater. In some implementations, the material forming the heat-sink layer 9 has a thermal degradation temperature of 180° C. or higher. In some implementations, the material forming the heat-sink layer 9 has a thermal degradation temperature of 240° C. or higher.

In some implementations, the heat-sink layer 9 may be formed from a metal or metal alloy. Stainless steel (such as stainless steel 304) has been found to be a suitable material. In this regard, stainless steel (e.g., such as stainless steel 304) has a specific heat capacity of approximately 502 J/kgK and a thermal conductivity of 14.4 W/mK. Materials such as gold, silver and copper tend to have lower specific heat capacities (125 J/kgK, 238 J/kgK and 376 J/kgK, respectively) and higher thermal conductivities (310 W/mK, 429 W/mK, 398 W/mK, respectively) than stainless steel. Thus, objects formed from these metals generally require less energy to raise the temperature of the object by 1° C., and therefore reach a higher overall temperature when supplied with the same amount of energy, although they are capable of more quickly transferring/distributing heat throughout the object than stainless steel. Other examples of suitable materials may be nickel, aluminium or nickel chromium. Nickel has a comparable specific heat capacity (502 J/kgK) to stainless steel, and a higher thermal conductivity (97.5 W/mK). Aluminium has a much higher specific heat capacity (921 J/kgK) than stainless steel, and also has a much higher thermal conductivity (88 to 251 W/mK). Nickel Chromium (NiCr8020), which is commonly used in heating elements in electronic cigarettes, has a slightly lower specific heat capacity (460 J/kgK), and a comparable thermal conductivity (13 W/mK) to stainless steel.

However, it should be appreciated that in other implementations, other materials may be used to form the heat-sink layer 9.

While it should be understood that modifications to the dimensions of the heat-sink layer 9 may help to offset a given specific heat capacity (e.g., a heat-sink layer 9 formed from gold may be formed thicker than an equivalent heat-sink layer 9 formed from stainless steel to yield similar performance as a heat-sink layer), considerations may be given to the dimensions of the heat-sink layer 9. For example, the cartomiser 3 is intended to be disposable and replaced when the reservoir 46 is depleted of liquid aerosol-generating material, and therefore minimising the mass of material utilised in the cartomiser 3 may be of significance. Additionally, the thickness of the heat-sink layer 9 may need to be selected so as to not substantially affect the supply of liquid to the heater assembly 6. In other words, increasing the thickness of the heat-sink layer 9 may also increase the distance any liquid aerosol-generating material has to travel (and subsequently the time taken) to reach the heater assembly 6 and subsequently the electrically resistive layer 64. Thus, heat-sink layers 9 which are formed too thick, may impact the performance characteristics of the heater assembly 6. Therefore, in some implementations, a balance is struck between a material having a high heat capacity (and specifically the mass thereof) and a high thermal conductivity. In some implementations, the heat-sink layer 9 is formed form stainless steel, such as stainless steel 304. However, it should be appreciated that depending on the implementation at hand, different materials, including any of those listed above, may be selected as materials for forming the heat-sink layer 9.

The heat-sink layer 9 is also configured to allow liquid aerosol-generating material to flow through the heat-sink layer 9 and subsequently to the lower major surface of the substrate 62/heater assembly 6. That is to say, the heat-sink layer 9 is permeable or porous to liquid aerosol-generating material. In particular, the heat-sink layer 9 is configured to allow aerosol-generating material to pass to the openings of the capillary tubes 66 of the central portion 67 of the heater assembly 6.

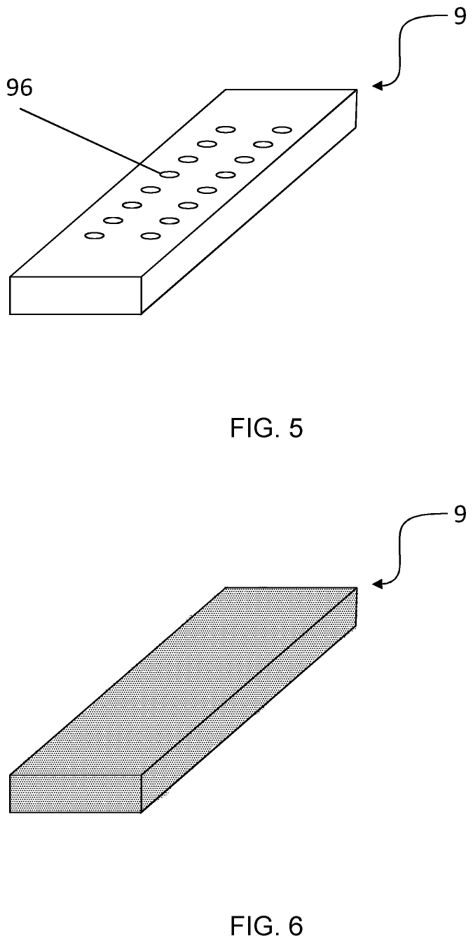

FIG. 5 schematically shows, in perspective view, the heat-sink layer 9 in accordance with a first implementation of the present disclosure.

The heat-sink layer 9 of FIG. 5 is formed as a planar structure (having a rectangular cuboid shape) and includes a plurality of through channels 96 extending from one surface (e.g. the surface in contact with the heater assembly) of the heat-sink layer 9 to the other surface. In the example of FIG. 5, only one surface of the heat-sink layer 9 comprising the openings of the through channels 96 is visible in FIG. 5, but it should be appreciated that the surface opposite the visible surface shown in FIG. 5 comprises corresponding openings of the through channels 96. In much the same way as with the capillary tubes 66 in FIG. 4, the openings of the through channels 96 in FIG. 5 are shown in an exaggerated way for clarity. In some implementations, the through channels 96 may be arranged so as to align with the capillary tubes 66 of the heater assembly 6. That is, the through channels 96 of the heat-sink layer 9 are arranged to be in direct fluid communication with the capillary tubes 66 of the heater assembly 6. The through channels 96 may have the same cross-sectional shape and/or dimensions as the corresponding capillary tubes 66 of the heater assembly 6. In other implementations, the through channels may have a cross-sectional area that is different from (e.g., greater than) the cross-sectional area of the capillary tubes 66. This may help to influence the direction of flow of the liquid aerosol-generating material along the through channels 96. In some implementations, the cross-sectional shape and/or dimensions of the through channels 96 may change in the thickness direction of the heat-sink layer 9. For example, the cross-sectional area and/or dimensions of the through channels 96 may decrease along the direction towards the heater assembly 6. This may also help influence the direction of flow of the liquid aerosol-generating material along the through channels 96.

In some implementations, the heater assembly 6 may be formed with one or more channels permitting the transport of liquid aerosol-generating material in a lateral direction of the heater assembly 6 (e.g., perpendicular to the direction of extent of the capillary tubes 66). For example, in some implementations, the heater assembly 6 may be formed from a porous substrate (such as a sintered material or a ceramic) having random arrangements of interconnected pores (or interstices) and/or have channels or grooves formed in the lower major surface of the substrate 62/heater assembly 6. The interconnected pores and/or grooves may receive liquid aerosol-generating material from the through channels 96 of the heat-sink layer 9 and subsequently facilitate the transport of the liquid aerosol-generating material to the capillary tubes 66 of the heater assembly 6 (and then onto the electrically resistive layer 64 as described). In such implementations, the through channels 96 need not necessarily align with the capillary tubes 66 of the heater assembly 6.

FIG. 6 schematically shows, in perspective view, the heat-sink layer 9 in accordance with a second implementation of the present disclosure.

The heat-sink layer 9 of FIG. 6 is formed as a planar structure (having a rectangular cuboid shape). However, unlike FIG. 5, the heat-sink layer 9 of FIG. 6 is formed from a porous material. For example, the heat-sink layer 9 is formed from a ceramic or a sintered structure. In some implementations, the heat-sink layer 9 is formed form sintered stainless steel (such as stainless steel 304). The sintered structure may be formed from sintered powders or fibres. As noted above, a porous structure includes a plurality of interconnected pores or interstices which define random pathways through the structure. In the case of the heat-sink layer 9, the random pathways are capable of permitting liquid to flow from one surface (e.g. the surface in contact with the heater assembly) of the heat-sink layer 9 to the other surface. Subsequently, liquid aerosol-generating material that is delivered through the random pathways provided by the interconnected pores or interstices is capable of being delivered to the capillary tubes 66 of the heater assembly 6. The heater assembly 6 may be formed from a porous substrate or an impermeable substrate.

It should also be appreciated that a heat-sink layer 9 may be provided which combines the through channels 96 with the porous material (such as sintered stainless steel). That is to say, the features described in FIG. 5 may be applicable to the implementation of FIG. 6 and vice versa.

Hence, in broad summary, the heat-sink layer 9 is provided adjacent the surface of the heater assembly 6 that faces the reservoir 46 comprising the liquid aerosol-generating material, such that it is positioned between the surface of the heater assembly 6 and the reservoir 46. The heat-sink layer 9 is configured to facilitate the absorption and distribution of heat energy generated by the heater assembly 6 in use through the heat-sink layer 9 and into the liquid aerosol-generating material adjacent the heater assembly 6. Accordingly, the heat-sink layer 9 is able to be more uniformly heated reducing the possibility of any local hot-spots formed at the second major surface of the substrate 62 from causing any damage or the like to the heat-sink layer 9. In addition, the heat-sink layer 9 is able to more uniformly heat or warm the liquid aerosol-generating material in the reservoir 46, thereby reducing the viscosity of the liquid in a more uniform manner at the heat-sink layer 9/at the second major surface of the substrate, thereby meaning that the liquid aerosol-generating material more uniformly interacts with the heater assembly 6 (as opposed to having hot spots of liquid at higher temperatures and therefore lower viscosities). Thus, more uniform performance characteristics of the heater assembly 6 may be realised. The heat-sink layer 9 is also configured to withstand the expected temperatures that the heat-sink layer 9 may be exposed to (in other words, the heat-sink layer 9 does not degrade during use). In addition, the heat-sink layer 9 is configured to permit liquid aerosol-generating material to pass through the heat-sink layer 9 in order to supply liquid aerosol-generating material to the heater assembly 6. The heat-sink layer 9 is therefore liquid aerosol-generating material permeable. The heat-sink layer 9 may be formed from a ceramic or sintered material having interconnected pores and/or has through channels 96 provided in the heat-sink layer 9 extending from one side to another side. In some implementations, the heat-sink layer 9 is formed from a sintered stainless steel (such as stainless steel 304) material. Such a sintered stainless steel material provides a good specific heat capacity and thermal conductivity, as well as providing good wicking/liquid aerosol-generating material transport functionality.

The heat-sink layer 9 may be provided as a separate component of cartomiser 3 (or more generally of the aerosol provision system 1). The heat-sink layer 9 may be held in place e.g., by the foot 51 of the upper clamping unit 5, when the upper clamping unit 5 and lower support unit 7 are brought together. However, in some implementations, such as described in FIGS. 2 and 3, the heat-sink layer 9 may be formed as part of the heater assembly 6. That is to say, the heater assembly 6 may comprise the heat-sink layer 9. For example, the heat-sink layer may be adhered or otherwise attached to the relevant surface (e.g., the lower major surface) of the heater assembly 6, to thereby form part of the heater assembly 6. That is to say, the heat-sink layer 9 may be provided as part of the aerosol provision system 1 separate from the heater assembly 6 or the heat-sink layer 9 may be provided as part of the heater assembly 6.

It should be appreciated that the configuration of the cartomiser 3 accommodating the heater assembly 6 and heat-sink layer 9 is provided as an example configuration of such a cartomiser 3. The principles of the present disclosure apply equally to other configurations of the cartomiser 3 (for example, comprising similar or different components to those as shown in FIGS. 1 to 3, and a similar or different layout to that shown in FIGS. 2 and 3). That is, the cartomiser 3 and the relative position of the heater assembly 6 and heat-sink layer 9 in the cartomiser 3 is not significant to the principles of the present disclosure. Broadly speaking, a cartomiser is likely to comprise a top end (having the mouthpiece orifice 41) and a bottom end. In the examples shown above, the heater assembly 6/heat-sink layer 9 is arranged to be below the reservoir 46, substantially horizontal to the longitudinal axis of the cartomiser 3, and arranged in an airflow path that initially impinges on the surface of the heater assembly 6 (the electrically resistive layer 64) before proceeding perpendicularly to longitudinal axis of the heater assembly 6 and up to the side channels 55. However, this need not be case, and in other implementations the cartomiser 3 may be configured differently depending on the particular design and application at hand. For example, the heater assembly 6 may be arranged such that airflow is substantially perpendicular to the longitudinal axis of the heater assembly, e.g., along the exposed surface of the electrically resistive layer 64. For example, an air passage may be provided to one side of the upper clamping unit 5. Air may enter the cartomiser 3 by a suitable inlet and flow along the longitudinal surface of the heater assembly 6 (and along the electrically resistive layer 64) before passing in a substantially vertical direction through an air tube positioned at one end of the upper clamping unit 5 (e.g., the end opposite the air inlet). The outer housing 4 and mouthpiece orifice 41 may be suitably configured. Hence, although the heater assembly 6 has been described in the specific context of the example cartomiser 3 of FIGS. 1 to 3, the principles described herein can be applied to different heater assemblies for use in different cartomisers 3.

In the example shown in FIGS. 2 and 3, the contact pads 75 directly contact the electrically resistive layer 64 of the heater assembly 6. However, the cartomiser 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomiser 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

In addition, in the described examples, the heater assembly 6 is orientated such that the electrically resistive layer 64 faces towards the bottom of the cartomiser 3. However, the orientation of the heater assembly 6 is not limited to this and, in other implementations, the heater assembly 6 may be provided in alternative orientations, for example, where the electrically resistive layer faces away from the bottom of the cartomiser 3.

It should also be appreciated that while the above has described a cartomiser 3 which includes the heater assembly 6, in some implementations the heater assembly 6 may be provided in the aerosol provision device 2 itself. For example, the aerosol provision device 2 may comprise the heater assembly 6 and a removable cartridge (containing a reservoir of liquid aerosol-generating material). The heater assembly 6 is provided in fluid contact with the liquid in the cartridge (e.g., via a suitable wicking element or via another fluid transport mechanism). Alternatively, the aerosol provision device 2 may include an integrated liquid storage area in addition to the heater assembly 6 which may be refillable with liquid. More broadly, the aerosol provision system (which encompasses a separable aerosol provision device and cartomiser/cartridge or an integrated aerosol provision device and cartridge) includes the heater assembly.

Additionally, the above has described a heater assembly 6 in which an electrically resistive layer 64 is provided on a surface of the respective substrate. In the aerosol provision system 1 of FIGS. 2 and 3, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro-or ferrimagnetic). More generally, the electrically resistive layer 64 is an example of a heater layer of the heater assembly 6 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66 still extend to an opening on the electrically resistive layer 64 but may additionally extend through the additional layer(s). More broadly, the capillary tubes 66 extend through the heater assembly 6 to an opening at a surface of a side of the heater assembly 6 comprising the electrically resistive layer 64, which includes an opening in the electrically resistive layer 64 itself as well as an opening in any additional layer(s) positioned above the electrically resistive layer 64.

While the above has described a heat-sink layer 9 being provided adjacent the exposed part of the second major surface of the substrate 62, in some implementations, it should be appreciated that the heat-sink layer 9 may be thermally coupled to a secondary heat-sink provided at a location that is different to the reservoir 46. For example, with reference to FIG. 3, the heat-sink layer 9 may extend to the left and/or right of the position shown in FIG. 3 to a secondary heat sink provided, e.g., in the region between the contact pad 75 and the edge of the lower support unit 7. In such an example, the relative heat capacity of the heat-sink layer 9 and the secondary heat sink combined may permit materials with a lower specific heat capacity to be used without compromising the fluid transfer capabilities (i.e., without being formed too thick in the regions of the capillary tubes 66 of the heater assembly 6), by virtue of the extra mass provided by the secondary heat-sink.

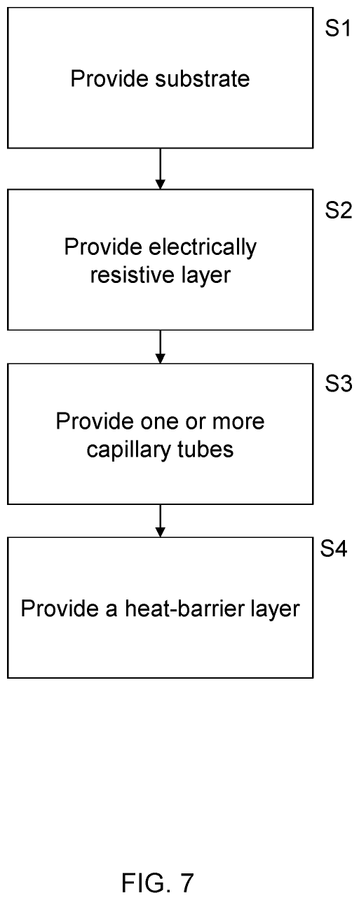

FIG. 7 depicts an example method for a heater assembly 6 and heat-sink layer 9 for an aerosol provision system 1 or an aerosol provision system 1 comprising a heater assembly 6 and a heat-sink layer 9.

The method begins at step S1 by providing a substrate 62. The way in which the substrate 62 is formed is not significant to the principles of the present disclosure. For example, the substrate 62 may be cut from a portion of cultured quartz or formed via a sintering process by sintering quartz powders/fibres, for example. In the present example method, the substrate 62 is provided broadly as a flat, planar substrate 62.

The method then proceeds to step S2 whereby the electrically resistive layer 64 is provided on a surface of the substrate 62. The way in which the electrically resistive layer 64 is formed on the surface of the substrate 62 is not significant to the principles of the present disclosure. For example, the electrically resistive layer 64 may be a sheet of metal (e.g., titanium) adhered, welded, or the like to the substrate 62. Alternatively, the electrically resistive layer 64 may be formed through a vapour or chemical deposition technique using the substrate 62 as a base.

It should also be appreciated that step S2 may alternatively occur before step S1. For example, a further alternative is to grow or culture the substrate 62 using the electrically resistive layer 64 as a base.

In the described example, after step S2, the method proceeds to step S3. At step S3, one or more capillary tubes 66 are formed in the substrate 62/electrically resistive layer 64 (or more generally, the heater assembly 6). As noted above, the capillary tubes 66 extend from a surface of the substrate 62/heater assembly 6 (the lower major surface 62), through the electrically resistive layer 64 provided at the upper major surface 62 of the heater assembly 6. That is, the capillary tubes 66 extend all the way through the heater assembly 6. The capillary tubes 66 may be formed by laser drilling, as noted above, or any other suitable technique.

It should be appreciated that step S3 may be performed prior to step S2 (and equally step S3 may follow step S1 where step S2 is performed prior to step S1). That is to say, the capillary tubes 66 may be formed in the substrate 62 prior to applying the electrically resistive layer 64.

The method of FIG. 7 then proceeds to step S4. At step S4, the heat-sink layer 9 is provided. The heat-sink layer 9 may be formed in any suitable way. For example, the heat-sink layer 9 may be cut from a bulk material, sintered from powders/fibers, etc. The specific way in which the heat-sink layer 9 is formed will depend on the implementation at hand. Additionally, the heat-sink layer 9 may be provided with one or more pathways for liquid aerosol-generating material to travel through the heat-sink layer 9 (such as the random interconnected pores). Alternatively, at step S4, the one or more through passages 96 may be formed in the heat-sink layer 9; for example, through laser drilling.

In some implementations, the heat-sink layer 9 may be integrally formed with the heater assembly 6. That is, the heat-sink layer 9 may be attached (e.g., affixed, adhered, or the like) to the lower major surface of the heater assembly 6. The heat-sink layer 9 and heater assembly 6 may then form one component (and may be referred to as a heater assembly 6 comprising a heat-sink layer 9). In such implementations, it may be convenient to perform step S3 after the heat-sink layer 9 is attached to the heater assembly 6 such that the capillary tubes 66 and the through channels 96 are formed simultaneously.

After step S4 is performed, either the heater assembly 6 is formed, and subsequently may be assembled to form the cartomiser 3 (or more generally, the heater assembly 6 may be positioned in an aerosol provision system 1), or the heat-sink layer 9 and heater assembly 6 are provided and may be used to form the cartomiser 3 (or more generally, the heater assembly 6 may be positioned in an aerosol provision system 1).

Broadly, it should be understood that the method of FIG. 7 is an example method only, and adaptations to the steps or ordering of the steps of this method are contemplated within this disclosure, for example, as described above.

Thus, there has been described an aerosol provision system, the aerosol provision system including an aerosol-generating material storage portion for storing aerosol-generating material, a heater assembly, where the heater assembly includes a substrate; a heater layer configured to generate heat when supplied with energy, the heater layer provided on a first surface of the substrate; and one or more capillary tubes extending from another surface of the substrate through the heater layer provided at the first surface of the substrate; and a heat-sink layer. The heater assembly is arranged such that at least the another surface is in fluid communication with the aerosol-generating material storage portion. The heat-sink layer extends across at least a part of the another surface of the substrate and is configured to allow aerosol-generating material to pass through the heat-sink layer to the one or more capillary tubes of the heater assembly. The heat-sink layer is configured to absorb heat energy generated by the heater layer and transmitted through the substrate and distribute the absorbed heat energy through the heat-sink layer. Also described is a heater assembly and a method for manufacturing a heater assembly and heat-sink layer.

While the above described embodiments have in some respects focussed on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An aerosol provision system, the aerosol provision system comprising:
an aerosol-generating material storage portion for storing aerosol-generating material;
a heater assembly, the heater assembly comprising:
a substrate;
a heater layer configured to generate heat when supplied with energy, the heater layer provided on a first surface of the substrate; and
one or more capillary tubes extending from another surface of the substrate through the heater layer provided at the first surface of the substrate; and
a heat-sink layer, wherein
the heater assembly is arranged such that at least the another surface is in fluid communication with the aerosol-generating material storage portion,
the heat-sink layer extends across at least a part of the another surface of the substrate and is configured to allow aerosol-generating material to pass through the heat-sink layer to the one or more capillary tubes of the heater assembly, and
the heat-sink layer is configured to absorb heat energy generated by the heater layer and transmitted through the substrate and distribute the absorbed heat energy through the heat-sink layer.

2. The aerosol provision system of claim 1, wherein the heat-sink layer is configured to dissipate the absorbed heat energy transmitted thorough the substrate from the heater layer to aerosol-generating material stored in the aerosol-generating material storage portion.

3. The aerosol provision system of claim 1, wherein the heat-sink layer is formed from a metal.

4. The aerosol provision system of claim 3, wherein the heat-sink layer is formed from stainless steel.

5. The aerosol provision system of claim 3, wherein the heat-sink layer is formed from sintered stainless-steel fibers or powder.

6. The aerosol provision system of claim 1, wherein the heat-sink layer comprises at least one of: a plurality of interconnected pores and one or more through channels, wherein the plurality of interconnected pores and the one or more through channels are configured to transport aerosol-generating material from one surface to another surface of the heat-sink layer, the another surface of the heat-sink layer being adjacent the another surface of the substrate.

7. The aerosol provision system of claim 6, wherein the average pore size of plurality of interconnected pores or a dimension of the cross-section of the one or more through channels is equal to or greater than a dimension of the cross-section of the openings of the one or more capillary tubes at the another surface of the substrate.

8. The aerosol provision system of claim 1, wherein the plurality of interconnected pores and/or the one or more through channels are configured to transport liquid aerosol-generating material.

9. The aerosol provision system of claim 1, wherein the heat-sink layer is formed from a material which has a specific heat capacity of 400 J/kgK or greater, or of 500 J/kgK or greater.

10. The aerosol provision system of claim 1, wherein the heat-sink layer is formed from a material which has a thermal conductivity of 10 W/mK or more, or of 15 W/mK or more.

11. The aerosol provision system of claim 1, wherein the heat-sink layer is formed from a material which has a thermal degradation temperature of 180° C. or greater, or 220° C. or greater.

12. The aerosol provision system of claim 1, wherein the heater assembly and the heat-sink layer are integrally formed.

13. A heater assembly for an aerosol provision system, the heater assembly comprising:
a substrate;
a heater layer configured to generate heat when supplied with energy, the heater layer provided on a first surface of the substrate;
one or more capillary tubes extending from another surface of the substrate through the heater layer provided at the first surface of the substrate; and
a heat-sink layer, wherein
the heater assembly is arranged such that at least the another surface is able to be placed in fluid communication with an aerosol-generating material storage portion,
the heat-sink layer extends across at least a part of the another surface of the substrate and is configured to allow aerosol-generating material to pass through the heat-sink layer to the one or more capillary tubes of the heater assembly, and
the heat-sink layer is configured to absorb heat energy generated by the heater layer and transmitted through the substrate and distribute the absorbed heat energy through the heat-sink layer.

14. A method for manufacturing a heater assembly and heat-sink layer for an aerosol provision system or an aerosol provision system comprising a heater assembly and a heat-sink layer, the method comprising:
providing a substrate;
providing a heater layer on a first surface of the substrate, the heater layer configured to generate heat when supplied with energy;
providing one or more capillary tubes extending from another surface of the substrate through the heater layer provided at the first surface of the substrate; and
providing a heat-sink layer, wherein
the heater assembly is arranged such that at least the another surface is in fluid communication with an aerosol-generating material storage portion or is able to be placed in fluid communication with an aerosol-generating material storage portion,
the heat-sink layer extends across at least a part of the another surface of the substrate and is configured to allow aerosol-generating material to pass through the heat-sink layer to the one or more capillary tubes of the heater assembly, and
the heat-sink layer is configured to absorb heat energy generated by the heater layer and transmitted through the substrate and distribute the absorbed heat energy through the heat-sink layer.

15. An aerosol provision means, the aerosol provision means comprising:
aerosol-generating material storage means for storing aerosol-generating material;
heater means, the heater means comprising:
a substrate;
a heater layer means configured to generate heat when supplied with energy, the heater layer means provided on a first surface of the substrate; and
capillary means extending from another surface of the substrate through the heater layer provided at the first surface of the substrate; and
heat-sink means, wherein
the heater means is arranged such that at least the another surface is in fluid communication with the aerosol-generating material storage means,
the heat-sink means extends across at least a part of the another surface of the substrate and is configured to allow aerosol-generating material to pass through the heat-sink means to the one or more capillary means of the heater means, and
the heat-sink means is configured to absorb heat energy generated by the heater layer means and transmitted through the substrate and distribute the absorbed heat energy through the heat-sink layer.

16. A heater means for an aerosol provision system, the heater means comprising:
a substrate;
a heater layer means configured to generate heat when supplied with energy, the heater layer means provided on a first surface of the substrate;
capillary means extending from another surface of the substrate through the heater layer provided at the first surface of the substrate; and
heat-sink means, wherein
the heater means is arranged such that at least the another surface is able to be placed in fluid communication with an aerosol-generating material storage means,
the heat-sink means extends across at least a part of the another surface of the substrate and is configured to allow aerosol-generating material to pass through the heat-sink means to the one or more capillary means of the heater means, and
the heat-sink means is configured to absorb heat energy generated by the heater layer means and transmitted through the substrate and distribute the absorbed heat energy through the heat-sink means.
